(19) United States
(12) Patent Application Publication
(10) Pub. No.: US 2002/0079274 A1
(43) Pub. Date: Jun. 27, 2002

(54) Filter plate, method of producing filter plate, use of filter plate in a rotary filter

(75) Inventor: Josef W. Tichy, Sonthofen (DE)

Correspondence Address: BAKER & BOTTS, 30 ROCKEFELLER PLAZA, NEW YORK, NY, 10112

(73) Assignee: BHS-Sonthofen, Sonthofen (DE)

(21) Appl. No.: 09/993,050

(22) Filed: Nov. 14, 2001

(30) Foreign Application Priority Data
Nov. 15, 2000 (DE) 100 56 518.2

(51) Int. Cl. B01D 33/15

(52) U.S. Cl. 210/780; 210/490; 210/499; 210/510.1; 210/459

(57) ABSTRACT

A filter plate (10) comprises a body (12) having at least one flow path (16) for fluid to be filtered and one filter medium arrangement (14) arranged in the at least one flow path (16) and connected to the body (12). The filter medium arrangement (14) is connected to the filter plate body (12) by sintering, soldering, gluing or bonding. Further, methods of producing the filter plate and its use in a rotary filter are disclosed.

### BACKGROUND OF INVENTION

The invention relates to a filter plate comprising a body having at least one flow path for the fluid to be filtered and a filter medium arrangement connected to the body and located in the at least one flow path.

Such filter plates are employed, for example, in rotary filters for separating fine solids from suspensions by vacuum filtration, pressure filtration or combined vacuum-pressure filtration, as disclosed, for example, in German Patents DE-PS 878,795 and DE-PS 922,226. These filters operate with excess pressure on the inlet side and/or negative pressure (or vacuum) on the outlet side to provide an active pressure differential for separating solids from suspensions. Known filter plates for use in these rotary filters are disclosed, for example, in Germany DE 3,732,188 C1 and DE 3,825,605 C2.

For such rotary filters, the use of multilayer metal fabric as a filter medium is known as well.

These metal fabrics, according to a first alternative, may be attached to the filter plate body by means of a tension cord. However, this mode of attachment is disadvantageous in a number of respects. For one thing, it involves a relatively costly step. For another, this method of fastening results in folds and pockets in the applied filter media, forming deposits of solids upon filtration that fail to be flushed out of the filter and cannot be dependably removed from the filter even by washing with high-pressure cleaning devices. Accordingly, DE 3,732,188 C1 and DE 3,825,605 C2 have recommended the use of specially preformed and therefore quite expensive filter medium arrangements.

According to a second alternative, actually employed in practice but not described in more detail in the cited patents, the filter medium may be connected to the filter plate body by welding. The advantage of welding consists primarily in the firm and secure combination of the filter medium arrangement and the filter plate body, affording reliable operation of the filter or filter plate even after a long service life.

The welding of the filter medium arrangement and the filter plate body is possible especially in the case of metal fabrics if the filter medium arrangement and the filter plate body are made of similar metallic materials, capable of being welded to each other, such as, for example, austenitic stainless steels, high-alloy nickel alloys (known for example under the name “Hastelloy”) or other metallic materials. A disadvantage in the attachment of the filter material by welding, however, is that only fabrics having a minimum mesh or pore diameter of about 5 to 20 microns can be used. Thinner fabrics are damaged by welding, because the great differences in thickness of material cause the thin filaments of the filter medium fabric to be incipiently fused by the liquid welding material to such an extent that it may melt through, thus creating a flaw in the fabric.

To avoid this problem, the use of compound fabrics or metallically sintered filter media is known.

The said composite fabrics may, for example, exhibit a laminar structure. Here, a very coarse fabric layer is followed by a finer one, this by a still finer one, and commonly in the third or fourth layer, an especially fine layer of metal fabric, representing the filter medium proper. Furthermore, there are known variants in which a still coarser fabric layer is arranged on the said layers as a protective stratum, firstly with the function of protecting the very fine filter fabric from all sorts of possible damage, and secondly serving for the welding of the composite fabric to the filter plates.

It is also part of the prior art to connect these fabrics to each other by the action of heat, fusing the fabrics at their points of contact, i.e., by sintering or the like methods of connection. It is known as well that the fabrics may be flattened somewhat, prior to formation of the laminar structure, between two rigid, hard rollers on their top and bottom sides, i.e., to calender them, so that the size and possibly also the number of points of contact for the ensuing thermal connection is increased. Calendering may also reduce the pore size of the fabric to a few microns.

Both the weaving of very fine metal fabrics and their calendering involve considerable problems, because of limited strength, and especially because of limited tearing strength of extremely fine metal filaments. Therefore, the use of metal fabrics is limited to a range of a few microns pore width or more; finer fabrics than this are not produced.

Therefore, to filter off very fine solids, i.e., solids requiring pore diameters of less than 1 micron, commonly the metallic sinter materials just referred to are employed. To produce these filter media, extremely fine powders are pressed to porous ceramic-like plates and then sintered.

As indicated above, both compound fabrics, preferably sintered compound fabrics, and metallic sinter filter media can be welded, similar to sheet-metal plates. They can, therefore, be employed as a substitute for a removable textile or metal fabric covering for filter plate bodies, and welded onto them.

A disadvantage of welded-on filter media, quite in general, is the strong thermal influence thereof on the material of the filter medium arrangement and of the filter plate body. This is especially true when austenitic chrome-nickel steels are employed, because due to the thermal influence the metallurgically and corrosion-wise desirable austenite may pass over into other less corrosion-resistant forms of metal. Subsequently, therefore, the corrosion-sensitive tempering colors must be removed. Besides, the welding operation is sometimes so difficult that the seam becomes uneven, and its roughness jeopardizes good deposition of solids after filtration, or cleaning after solid deposition.

Especially disadvantageous are the two methods of attachment discussed above for filter medium arrangements on filter plate bodies when the filter plates or filters so produced are employed in production installations where utmost cleanliness of equipment before and after an operation is important, as, for example, in the case of biological and pharmaceutical applications. Here, an entrainment of solids from one operation into the next is not tolerable. But even when filter plates are used for filtration of pigments, good cleanability is required whenever different colors are to be processed on one and the same apparatus in successive campaigns. An entrainment of pigment from one campaign into the next naturally leads to a diminution of quality.

### SUMMARY OF THE INVENTION

The object of the invention, then, is to develop the generic filter plate in such a way that even with small pore diameter of the filter medium arrangement, damage to or other disadvantageous influence on the filter medium arrangement can be avoided in the production of the filter plate, and this preferably with good filter cake deposition and good cleanability of the filter plate.

This object is accomplished, according to the invention, by a filter plate of the kind initially mentioned, in which the filter medium arrangement is connected to the filter plate body by sintering, soldering, gluing or bonding. Even in sintering or soldering, the material of the filter medium arrangement is subjected to less thermal load than in the familiar welding. Furthermore, in all these modes of connection, maintenance of the original highly corrosion-resistant structure of the material is assured. Lastly, it has been discovered, surprisingly, that despite the supposedly lesser strength of the connection by sintering, soldering, gluing and bonding as compared to a welded connection, dependable service of the filter plate is reliably assured, even after a considerable length of time in service.

As already indicated in the discussion of the prior art, the filter medium arrangement may comprise at least one filter medium layer formed by a filter fabric and/or at least one filter medium layer formed by porous sintered material, for example sintered metal or sintered ceramic.

According to a first modified embodiment, the filter medium arrangement may comprise a laminar structure of a plurality of fabric layers of various fineness. For example, the laminar structure may be composed of at least three layers, with a coarse fabric layer, a finer fabric layer and an especially fine fabric layer, the fineness of the fabric layers of the laminar structure preferably increasing towards the filter plate inlet, i.e., against the direction of flow of the fluid to be filtered. In this way, the finest fabric layer serves as the filter medium proper, while the coarser fabric layers serve firstly as supporting grid for the finest fabric layer and secondly prevent the accumulation of solids in the filter medium arrangement. The laminar structure may be additionally covered on the inlet side by a coarser fabric layer, protecting the fabric layer serving as filter medium proper from damage.

In this first modified embodiment, not all fabric layers, i.e., not the entire laminar structure, need be connected to the body by sintering or bonding or soldering. Rather, it suffices if the fabric layer serving as filter medium proper or the additional coarser fabric layer is connected to a filter medium contact surface of the filter plate body.

At least one of the fabric coverings, in particular the fabric covering connected to the body, may be made of metal fabric, or (that is to say) should be made of metal if the connection between the filter medium arrangement and the body is produced by sintering or soldering.

According to a second modified embodiment, the filter medium arrangement may comprise a laminar structure of a plurality of sintered layers of material of differential fineness. Here, a rather coarse layer of sintered material may form a base layer, to which a covering layer of especially fine sintered material is applied. Alternatively, the base layer may be made up of a rather coarse layer of sintered material and at least one finer layer of sintered material deposited thereon. In either case, all layers and the filter plate may be connected together, for example by sintering. According to the foregoing, then, in accordance with this second embodiment also, the fineness of the layers of sintered material in the laminar structure may increase towards the filter plate inlet, i.e., against the direction of flow of the fluid to be filtered.

In principle, however, it is possible also to combine the two modified embodiments discussed above with each other; for example, by providing a fine metal fabric as the filter medium proper on a base layer of sintered material, in particular sintered metal.

In another aspect, the invention further relates to a method for the production of a filter plate according to the invention.

In further development of this method for production, it may be provided that the filter plate body and/or the at least one filter fabric layer and/or the at least one layer of sintered material, before being connected, are subjected to a surface treatment to obtain an especially smooth, dirt-repellant surface. This surface treatment may, for example, comprise an electric polishing and/or the application of a dirt-repellant surface coating. Additionally or alternatively, the inlet surface of the filter medium arrangement, after connection of the filter plate body and the filter medium arrangement, may be finish-dressed and/or finish-ground to provide a smooth surface.

Finally, the invention relates also to the use of a filter plate according to the invention in a rotary filter. In particular, the filter plate according to the invention may be employed in rotary filter sections where the filter cake is treated with steam, i.e., washed out with steam and/or dehydrated by means of steam. Additionally, the filter plate according to the invention is suitable for service in rotary filter sections where it is exposed to highly corrosive stresses.

The invention will now be illustrated in more detail in embodiments by way of example, with reference to the accompanying drawings, in which

### BRIEF DESCRIPTION OF THE DRAWINGS

FIG. 1 shows a partial section of a first embodiment of a filter plate according to the invention, having a filter medium arrangement made up of a composite fabric;

FIG. 2 shows an enlarged representation of detail A in FIG. 1;

FIG. 3 shows a view, similar to FIG. 1, of a filter plate according to the invention, having a simply built-up filter plate body; and

FIGS. 4 and 5 show views, similar to FIG. 1, of filter plates according to the invention, with a sintered metal filter medium arrangement.

### DESCRIPTION OF ILLUSTRATIVE EMBODIMENTS

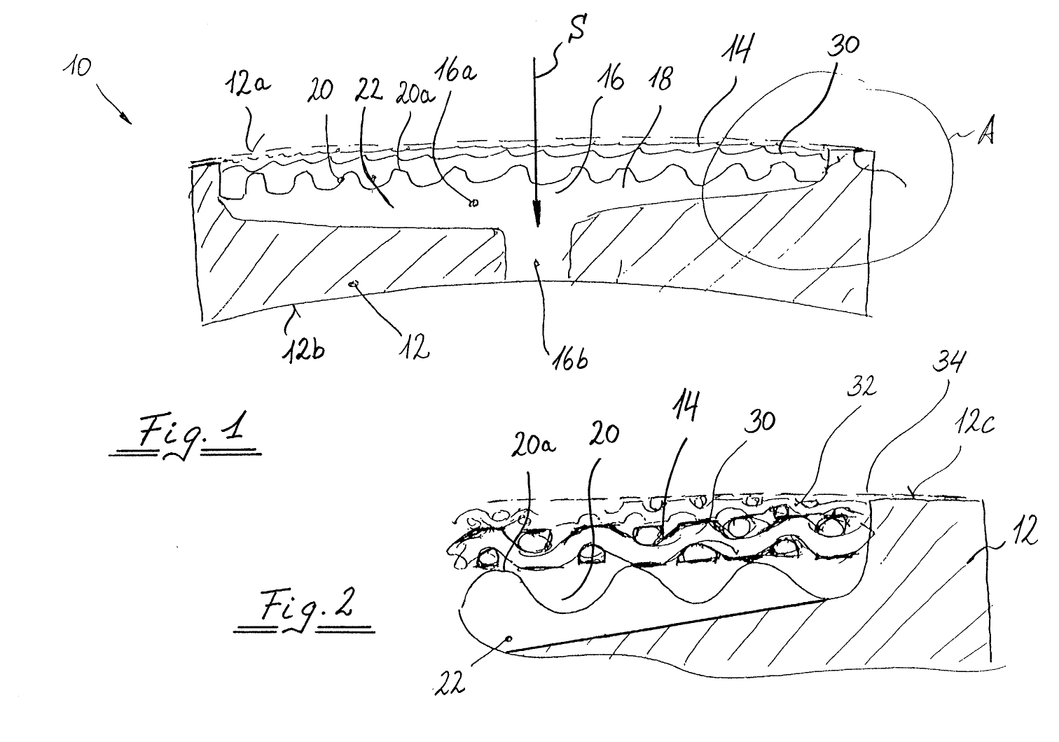

In FIG. 1, a filter plate according to the invention, quite in general, is designated 10. The filter plate 10 comprises a filter plate body 12, which may, for example, be fabricated as a stainless steel casting, as well as a filter medium arrangement 14.

The body 12 is traversed by a fluid passage extending from an inlet surface 12a of the body 12 to its outlet surface 12b, thus forming a flow path 16 for the fluid to be filtered. An inlet-side segment 16a, that is, a segment adjoining the surface 12a, of the flow path 16, is enlarged to accommodate the filter medium arrangement 14, while an outlet-side segment 16b of the flow path 16 is formed as outlet passage having a suitable cross-section for connection to external terminal lines. At the bottom of the chamber 18 formed by segment 16a of the flow path channelings 20 are formed to accommodate the filter medium arrangement 14, providing for a well-ordered discharge of filtrate. The channelings 20 open into collecting passages 22 leading to the filtrate discharge 16b.

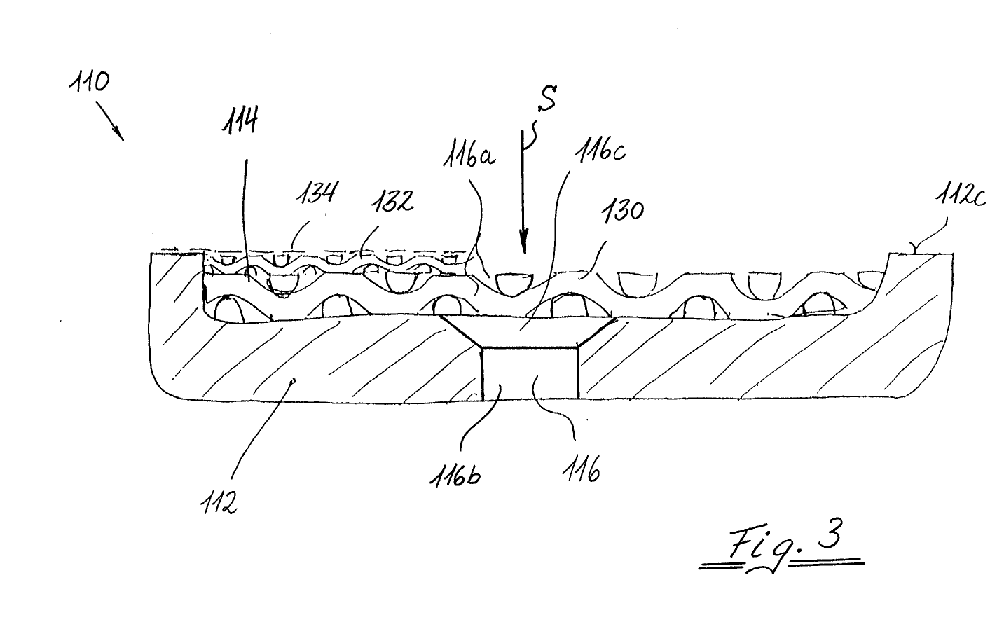

In the embodiment shown by way of example in FIG. 1, the filter medium arrangement 14 is formed by three layers of fabric arranged one above another against the direction of flow S (see also detail A in FIG. 2). A coarse-meshed fabric layer 30 serves to support the filter medium arrangement 14 on the peaks 20a of the channelings 20. A fine-meshed fabric covering 34, arranged on the surface of the filter medium arrangement 14 facing the surface 12a of the body 12, serves as filter medium proper, on whose surfaces the filter cake is deposited. Between the coarse-meshed fabric layer 30 and the fine-meshed fabric layer 34, an additional fabric layer 32 of intermediate mesh or pore diameter is arranged.

The purpose of the fabric layer 32 is chiefly to compensate the great mesh diameter gap between the fabric layers 30 and 34, which might lead to undesirable distortions of the fine-meshed fabric layer 34.

As may be seen in FIG. 2 from the example of fabric layers 30 and 32, these layers have been flattened on their tops and bottoms by calendering, i.e., by pressing between two rigid, hard cylinders. Further, it may be seen in FIG. 2 that the fine-meshed fabric layer 34 is cut larger than the fabric layers 30 and 32. In fact, the fabric layer 34 is preferably cut so ample that it firstly covers a filter medium contact surface 12c of the body 12, but secondly does not extend laterally beyond the body 12.

If the fabric layer 34 is made of metal, it may simply be connected to the body 12 in the vicinity of the contact surface 12c by sintering. Here, it is possible in principle that the coarse-meshed fabric layers 30 and 32 serving to support the fine-meshed layer 34 are arranged loose in the chamber 18 accommodating the filter medium. To enhance the over-all stability and dependability of operation of the filter plate 10, however, it is preferred for the fabric layers 30 and 32 to be connected to the body 12, and/or to the fine-meshed fabric layer 34 as well.

If the fabric layers 30 and 32 are likewise made of metal, then in a first operation they may be sintered to the fabric layer 34 to form the filter medium arrangement 14, an operation facilitated by prior calendering of the fabric layers. By subsequent re-sintering, the filter medium arrangement 14 thus obtained can be connected to the body 12. Alternatively, however, it is also possible to connect the fabric layers 30, 32 and 34 to each other and to the body 12 by a single sintering operation.

Additionally or alternatively to sintering, the connection of the fabric layers 30, 32 and 34 and the body 12 may be accomplished completely or partially by soldering, gluing or bonding.

To ensure the subsequent serviceability of the filter plate in high-purity operating environments, the fabric layers 30, 32 and 34 and the body 12, or at least some of these parts, may be surface-treated, creating an especially smooth, dirt-repellant surface. An example of such a surface treatment is the performance of an electric polishing operation.

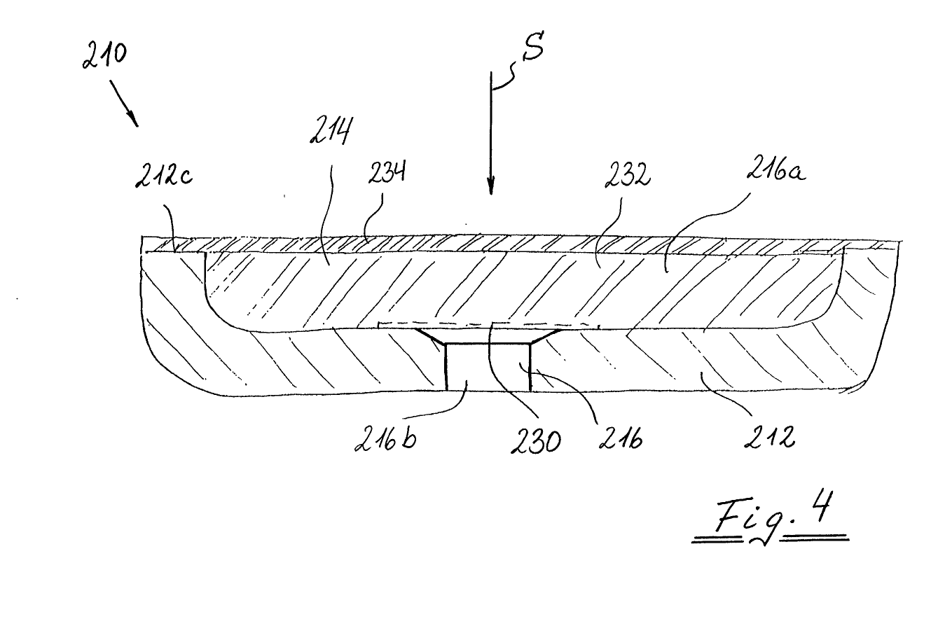

The embodiment according to FIG. 3 differs from the embodiments according to FIGS. 1 and 2 only in that the body 112 of the filter plate 110 exhibits an especially simple structure, since the formation of channelings and collecting passages has been dispensed with. The fluid passage 116 is formed with a transition segment 116c expanding against the direction of flow S only in the transition region between the enlarged segment 116a and the outlet segment 116b. Regarding the structure of the filter medium arrangement 114 made up of fabric layers 130, 132 and 134 and their connection to the body 112 by way of the fabric layer 134 in the region of the contact surface 112c, reference is made to the description of the embodiment according to FIGS. 1 and 2.

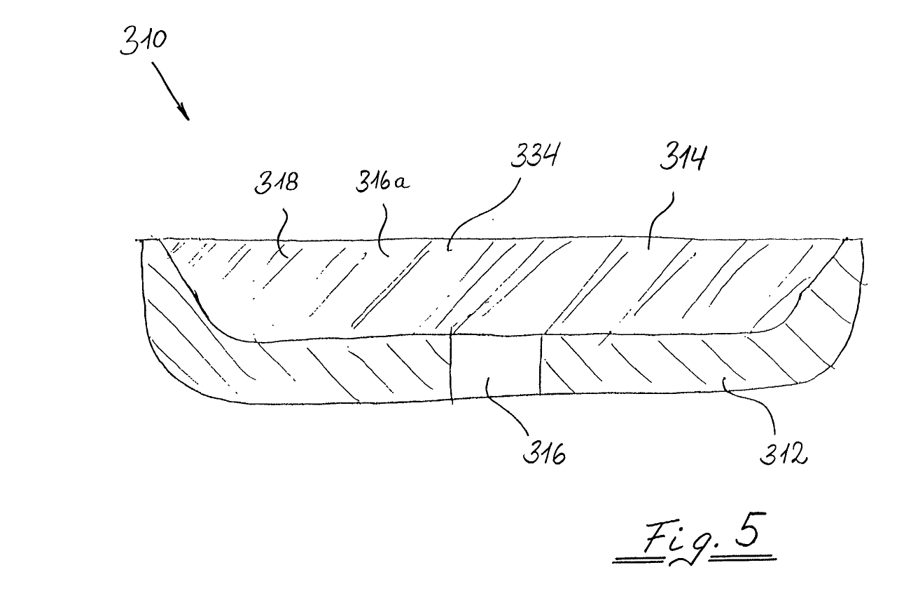

FIG. 4 shows a filter plate 210 whose filter medium arrangement 214 is configured as a composite plate of sintered material, in particular sintered metal. This composite plate comprises, in the direction opposite to the direction of flow S, i.e., from the outlet segment 216b to the inlet segment 216a of the flow path 216, first a segment 230 made up of coarse drainage material. Over this drainage layer 230, another, finer drainage layer 232 is arranged, which, however, is still made up of comparatively coarse sinter material, consequently exhibiting good drainage properties. The layer 234 of filter medium proper, which overlies the layer 230, is made of an especially fine sinter material, selected to meet the requirements of filter fineness. As in the case of the embodiments previously described, the filter layer 234 proper extends into the region of the contact surfaces 212c of the filter plate body 212, and is there connected thereto. Likewise, the drainage layers 232 and 230 connect to the body 212 upon sintering.

An especially simple embodiment of a filter plate 310 having a filter arrangement 314 produced from sintered material is shown in FIG. 5. In this embodiment, a single layer 334 of porous sintered material is arranged, and connected to the body 312 by sintering, in the enlarged segment 316a of the fluid flow path 316, or in the chamber 318 of the filter plate body 312 accommodating the filter medium.

Although the invention has been described and illustrated herein by reference to specific embodiments thereof, it will be understood that such embodiments are susceptible of variation and modification without departing from the inventive concepts disclosed. All such variations and modifications, therefore, are intended to be included within the spirit and scope of the appended claims.

What is claimed is:

1. A filter plate comprising:
a body having at least one flow path for fluid to be filtered, and
a filter medium arrangement arranged in the at least one flow path and connected to the body, the filter medium arrangement being connected to the filter plate body by sintering, soldering, gluing or bonding.

2. The filter plate according to claim 1, wherein the filter medium arrangement comprises at least one filter medium layer formed by a filter fabric.

3. The filter plate according to claim 2, wherein the filter medium arrangement comprises a laminar structure of a plurality of fabric layers of different fineness.

4. The filter plate according to claim 3, wherein:
the filter plate has an inlet for fluid to be filtered; and
the fineness of the fabric layers of the laminar structure increases towards the filter plate inlet.

5. The filter plate according to claim 3, wherein the laminar structure is additionally covered on the inlet side by a coarser fabric layer.

6. The filter plate according to claim 3, wherein the terminal fabric layer on the inlet side is connected to a filter medium contact surface of the filter plate body.

7. The filter plate according to claim 5, wherein the additional coarser fabric layer is connected to a filter medium contact surface on the filter plate body.

8. The filter plate according to claim 3, wherein at least one of the fabric layers is made of metal fabric.

9. The filter plate according to claim 1, wherein the filter medium arrangement comprises at least one filter medium layer made of porous sintered material.

10. The filter plate according to claim 9, wherein the at last one filter medium layer is made of sintered metal or sintered ceramic.

11. The filter plate according to claim 9, wherein the filter medium arrangement comprises a laminar structure of a plurality of layers of sintered material of different fineness.

12. The filter plate according to claim 11, wherein the fineness of the layers of sintered material in the laminar structure increases in the direction of the filter plate inlet.

13. A method for producing a filter plate according to claim 1, comprising the step of connecting the filter medium arrangement to the filter plate body by sintering, soldering, gluing or bonding.

14. The method according to claim 13, wherein the filter medium arrangement comprises at least one of a filter fabric layer and a layer of sintered material, and wherein the method further comprises the step of subjecting the filter plate body and/or the filter fabric layer and/or the layer of sintered material to a surface treatment prior to connection thereof.

15. The method according to claim 14, wherein said surface treatment step comprises electropolishing.

16. The method according to claim 14, wherein said surface treatment step comprises the provision of a dirt-repellant surface coating.

17. The method according to claim 13, wherein the method further comprises the step of subjecting the inlet-side surface of the filter medium arrangement to finish-dressing and/or finish-grinding after connection of the filter plate body and the filter medium arrangement.

18. A method of using at least one filter plate according to claim 1, comprising the step of incorporating said filter plate into a rotary filter for fine filter media to separate fine solids from suspensions by pressure filtration, vacuum filtration, or combined vacuum-pressure filtration.
